(19) United States
(12) Patent Application Publication
(10) Pub. No.: US 2018/0142814 A1
(43) Pub. Date: May 24, 2018

(54) SEAL AND PIPE CARRIER UNIT FOR A SUBSEA PIPE CONNECTION

(71) Applicant: HELLENES SUBSEA AS, Førde (NO)

(72) Inventor: Egil ERIKSEN, Vassenden (NO)

(21) Appl. No.: 15/575,268

(22) PCT Filed: May 19, 2016
(86) PCT No.: PCT/NO2016/050094

§ 371 Date: Nov. 17, 2017

(30) Foreign Application Priority Data
May 20, 2015 (NO) 20150628
May 18, 2016 (NO) 20160834

(51) Int. Cl. F16L 19/02; F16L 19/00; F16L 41/14

(52) U.S. Cl. CPC F16L 19/0206; F16L 41/14; F16L 19/0212; F16L 19/005

(57) ABSTRACT

A pipe connection and a method for sealingly connecting pipes which, in their opposite end portions, are provided with removable rings arranged in grooves provided in the peripheries of the pipes, the pipe connection being provided with a first nut, which is provided with an internally threaded portion and is arranged to encircle the end portion of the first pipe and has a shoulder portion which may abut in an axially supporting manner against said ring, and a second nut, which is provided with an externally threaded portion and is arranged to encircle the end portion of the second pipe and abut with a shoulder portion in an axially supporting manner against said ring, and the nuts are in threaded engagement with each other and are arranged to press radial pipe-end faces of the pipes against an axially supporting portion of a seal and pipe carrier.

The invention relates to a pipe connection for sealingly connecting a first pipe and a second pipe which are provided, at their opposite end portions, with removable rings arranged in grooves provided in the peripheries of the pipes, the pipe connection being provided with a first nut which is provided with an internally threaded portion, is arranged to encircle the end portion of the first pipe and is provided with a shoulder portion which may abut in an axially supporting manner against said ring, and a second nut which is provided with an externally threaded portion, is arranged to encircle the end portion of the second pipe and is provided with a shoulder portion which may abut in an axially supporting manner against said ring, the nuts being in threaded engagement with each other and being arranged to press radial pipe-end faces of the pipes against an axially supporting portion of a seal and pipe carrier unit which is enclosed by the nuts.

The invention also relates to a pipe connection for sealingly connecting a machined block and a pipe which is provided, at its end portion, with a removable ring arranged in a groove provided in the periphery of the pipe, the pipe connection being provided with a nut which is provided with an internally threaded portion, is arranged to encircle the end portion of the pipe and is provided with a shoulder portion which may abut in an axially supporting manner against said ring, and a connecting socket which is fixed to said block and projects from a seal face encircling a port, is provided with an externally threaded portion and is arranged to encircle the end portion of the pipe, the nut and the connecting socket being in threaded engagement with each other and surrounding a seal and pipe carrier unit and being arranged to press a radial pipe-end face of the pipe against an axially supporting portion of the seal and pipe carrier unit and an end face of the seal and pipe carrier unit against said seal face.

Finally, the invention relates to a method of sealingly connecting a first pipe and a second pipe or a machined block and a pipe by means of a pipe connection.

For underwater use, there are requirements for double sealing and sealing against both external and internal pressures. A high standard of straightness is required in the assembly of flanges and pipes in such situations.

Welding high-pressure pipes in materials such as super duplex steel is demanding and, in many applications, weld-free connections are to be preferred for thick-walled pipes with high working pressure, in which the pipe connection is under load and may be subjected to pressure pulses and vibration.

Using flange joints in which a rotatable flange has been fitted to a pipe end and mounts a pipe to an opposite flange or to a machined block is prior art. An advantage in relation to all-welded structures is that the components can be disassembled. The flange rests against a locking ring, which lies in a machined groove on the pipe end, and when the flanges are made up, the pipe end is pressed against a seal element. Connecting flanges with bolts requires a high standard of correct assembly in order to get a straight connection and, normally, only certified personnel are allowed to make up the connection. WO 2009/144359 A1 discloses a high-pressure flange solution.

U.S. Pat. No. 4,927,192 A shows a pipe connector with internally and externally threaded nuts that are in engagement with each other, each nut abutting against a ring which is placed in a groove on the end of each one of two pipes that are to be connected to each other. When being tightened, the pipe ends are brought towards each other and pressed against a seal element between the pipe ends.

U.S. Pat. No. 4,364,517 A discloses a connector between a pipe and a block with an outer locking nut.

WO0017548 A1 shows a connector with a locking nut and a seal- and pipe-holder.

EP0231076 A1 discloses the use of a setscrew to lock the nut and sleeve in a pipe connector.

The invention has for its object to remedy or reduce at least one of the drawbacks of the prior art or at least provide a useful alternative to the prior art.

The object is achieved according to the invention through the features that are specified in the description below and in the claims that follow.

A pipe connection provided with a seal and pipe carrier unit, often referred to as a “seal carrier”, is provided, which, by means of primary and secondary seals, ensures double sealing of the pipe connection, that is to say prevents leakage at both internal and external positive pressures, and ensures the axial orientation and precise guidance of the pipe ends during make-up. The seals are arranged between pipe-end faces and an axially supporting portion of the seal and pipe carrier unit, and between the pipe periphery and a surrounding sleeve-shaped portion of the seal and pipe carrier unit, alternatively between a pipe-end face and an axially supporting portion of the seal and pipe carrier unit, between the pipe periphery and a surrounding sleeve-shaped portion of the seal and pipe carrier unit and between an end face of the seal and pipe carrier unit and a seal face encircling a port on a machined block, for example a valve housing.

The invention is defined by the independent claims. The dependent claims define advantageous embodiments of the invention.

In a first aspect, the invention relates more specifically to a pipe connection for sealingly connecting a first pipe and a second pipe which are provided, at their opposite end portions, with removable rings arranged in grooves provided in the peripheries of the pipes, the pipe connection being provided with
a first nut which is provided with an internally threaded portion, is arranged to encircle the end portion of the first pipe and is provided with a shoulder portion which may abut in an axially supporting manner against said ring, and
a second nut which is provided with an externally threaded portion, is arranged to encircle the end portion of the second pipe and is provided with a shoulder portion which may abut in an axially supporting manner against said ring,
the nuts being in threaded engagement with each other and being arranged to press radial pipe-end faces of the pipes against an axially supporting portion of a seal and pipe carrier unit enclosed by the nuts, characterized by
the axially supporting portion being provided with parallel abutment faces projecting radially inwards, which are each provided with a primary-seal groove provided with a primary seal arranged to sealingly abut against said pipe-end faces, and
there being, extending axially in both directions from the axially supporting portion, sleeve-shaped radially supporting portions which are provided, internally, with respective secondary-seal grooves with secondary seals arranged to abut sealingly against the peripheries of the pipes.

In a second aspect, the invention relates more specifically to a pipe connection for sealingly connecting a machined block and a pipe which is provided, in its end portion, with a removable ring arranged in a groove provided in the periphery of the pipe, the pipe connection being provided with
a nut which is provided with an internally threaded portion, is arranged to encircle the end portion of the pipe and is provided with a shoulder portion which may abut in an axially supporting manner against said ring, and
a connecting socket which is fixed to said block and projects from a seal face encircling a port, is provided with an externally threaded portion and is arranged to encircle the end portion of the pipe,
the nut and the connecting socket being in threaded engagement with each other and surrounding a seal and pipe carrier unit and being arranged to press a radial pipe-end face of the pipe against an axially supporting portion of the seal and pipe carrier unit and an end face of the seal and pipe carrier unit against said seal face, characterized by
the axially supporting portion being provided with an abutment face projecting radially inwards, which is parallel to said end face and which is provided with a primary-seal groove provided with a primary seal arranged to abut sealingly against said pipe-end face or against said seal face, and
there being, extending axially from the axially supporting portion, a sleeve-shaped radially supporting portion which is provided, internally, with a first secondary-seal groove provided with a secondary seal arranged to abut sealingly against the periphery of the pipe, and
said end face being provided with a second secondary-seal groove encircling the primary-seal groove of the end face and being provided with a secondary seal arranged to sealingly abut against said seal face.

The primary seal may be a metal seal.

The secondary seal may be an elastomeric seal. Alternatively, the secondary seal may be an elastomeric seal provided with at least one removable supporting ring.

The nut that is provided with an internally threaded portion may be provided with at least one threaded radial bore arranged to receive a setscrew for locking the nut relative to the corresponding threaded portion.

In a third aspect, the invention relates more specifically to a method of sealingly connecting a first pipe and a second pipe or a machined block and a pipe by means of a pipe connection as described above, characterized by the method including the steps:
placing a seal and pipe carrier unit with associated primary and secondary seals between pipe-end faces of adjacent pipes, possibly between the pipe-end face of a pipe and a seal face encircling a port on an adjacent block;
connecting a nut to a corresponding threaded portion in the pipe connection;
pulling the pipe connection together by means of the nut in order thereby to bring said seals into sealing abutment against the pipe-end faces of the pipes, or against the pipe-end face of the pipe and the seal face.

The method may include the further step:
locking the nut to the corresponding threaded portion with at least one setscrew which is arranged in a threaded radial bore in the nut.

In what follows, an example of a preferred embodiment and method is described, which is visualized in the accompanying drawings, in which:

FIG. 1 shows a perspective sketch of a connection between two pipes formed of a pipe connection comprising a seal and pipe carrier unit according to the invention;

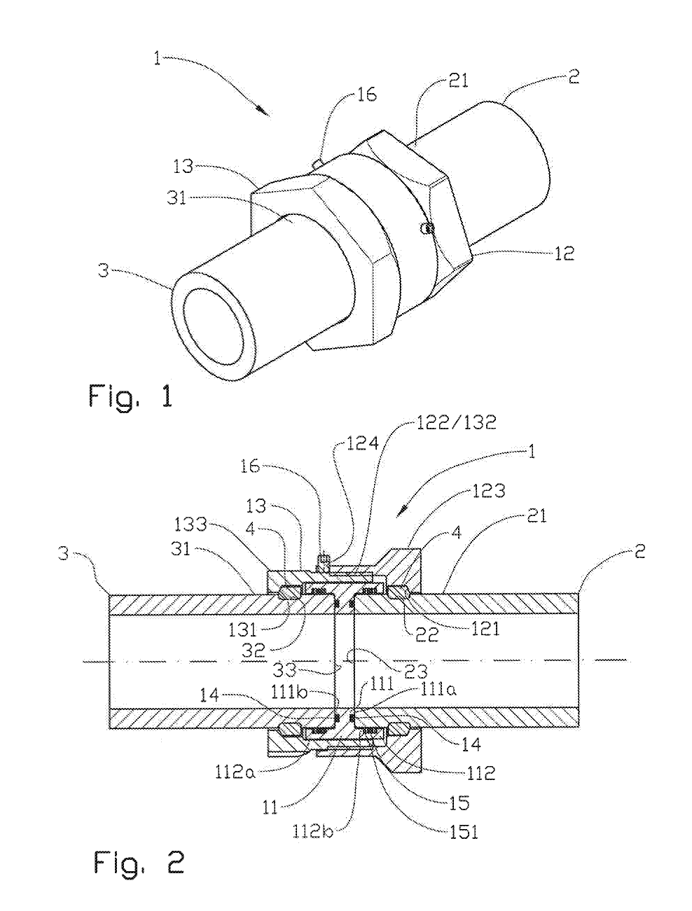

FIG. 2 shows an axial section of the pipe connection according to FIG. 1;

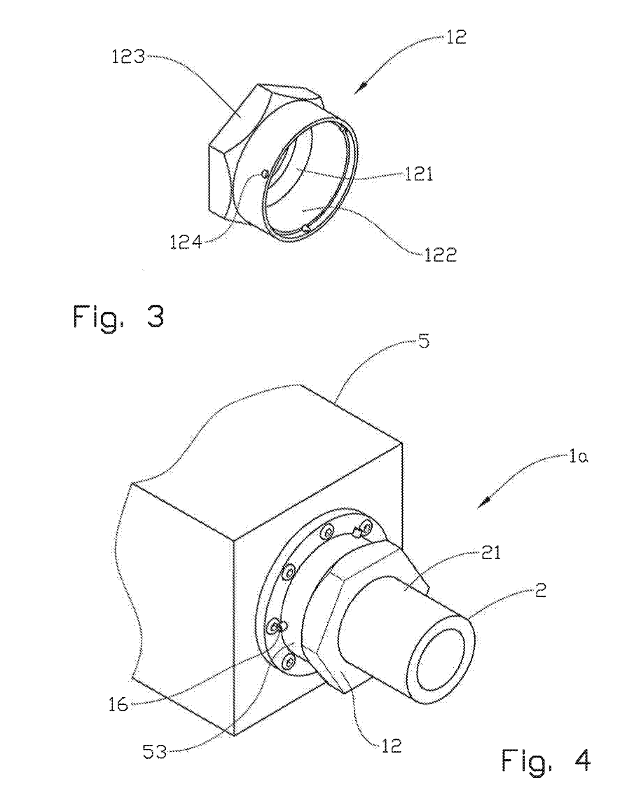

FIG. 3 shows a perspective sketch of a nut with threaded holes for radially positioned setscrews;

FIG. 4 shows a perspective sketch of a connection between a pipe and a machined block formed of a pipe connection comprising a seal and pipe carrier unit according to the invention; and

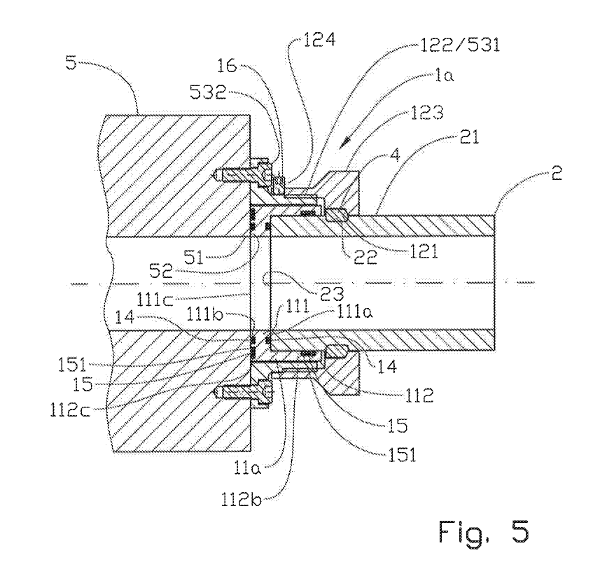

FIG. 5 shows an axial section of the pipe connection according to FIG. 4.

Reference is first made to FIGS. 1 and 2, in which the reference numeral 1 indicates a pipe connection for sealingly connecting first and second pipes 2, 3. The pipe connection 1 is provided with a first nut 12 with an internally threaded portion 122, and a second nut 13 with an externally threaded portion 132.

Said nuts 12, 13 have been passed over respective pipes 2 and 3, and are abutting with their shoulder portions 121 and 131, respectively, against respective removable rings 4 which are fitted in machined grooves 22 and 32, respectively, in end portions 21 and 32, respectively, on the pipes 2, 3. The nuts 12, 13 are in threaded engagement with each other.

In the pipe connection 1 for connecting two pipes 2, 3, a seal and pipe carrier unit 11 is positioned, encircled by the nuts 12, 13. A middle portion forms an axially supporting portion 111 with parallel abutment faces 11a projecting radially inwards, each provided with a primary-seal groove 111b. Extending axially in both directions from the middle portion, there are sleeve-shaped radially supporting portions 112, 112a, which are each provided, internally, with a secondary-seal groove 112b.

The primary-seal groove 111b of the seal and pipe carrier unit 11 is arranged to receive a primary seal 14, typically in the form of a metal seal, arranged to abut against a pipe-end face 23, 33 of the adjacent pipe 2, 3.

The secondary-seal groove 112b of the seal and pipe carrier unit 11 is arranged to receive a secondary seal 15, typically in the form of an elastomeric seal, shown here with associated supporting rings 151, arranged to abut against the periphery of the surrounded pipe 2, 3.

As appears from FIGS. 4 and 5, a variant 1a of the pipe connection may be used to fix a pipe 2 to a machined block 5, for example a valve housing or a pump housing, by a nut 12, which abuts in an axially supporting manner against the removable ring 4 of the pipe 2, having been screwed in over a connecting socket 53 with an externally threaded portion 531 projecting from a seal face 52 surrounding a port 51 which communicates with a fluid passage in the block 5. Here, the connecting socket 53 is shown attached to the block 5 by means of several fixing screws 532.

In the pipe connection 1a for the connection of the pipe 2 and the machined block 5, a seal and pipe carrier unit 11a is positioned, encircled by the nut 12 and the connecting socket 53. From an end portion forming an axially supporting portion 111, a sleeve-shaped radially supporting portion 112 extends axially, provided, internally, with a secondary-seal groove 112b. An end portion forms an axially supporting portion 111 with an abutment face 111a projecting radially inwards and being parallel to an end face 111c. Each of the abutment face 111a and the end face 111c is provided with a primary-seal groove 111b. On the end face 111c, a second secondary-seal groove 112c has been arranged as well, encircling the primary-seal groove 111b of the end face 111c.

The primary-seal grooves 111b of the seal and pipe carrier unit 11a are arranged to receive primary seals 14, typically in the form of metal seals, arranged to abut against the pipe-end face 23 of the adjacent pipe 2 and against the seal face 52 of the machined block 5, respectively.

The secondary-seal grooves 112b of the seal and pipe carrier unit 11 are arranged to receive secondary seals 15, typically in the form of elastomeric seals, shown here with associated supporting rings 151, arranged to abut against the periphery of the surrounded pipe 2 and against the seal face 52 of the machined block 5.

The pipe connection 1 is pulled together by the first nut 12 and the second nut 13 being screwed together and tightened to a moment, such that the primary seals 14 are sealing against internal positive pressure in the pipes 2, 3. Correspondingly, the nut 12 is screwed in over the externally threaded connecting socket 53 when the pipe 2 is being fitted to the machined block 5, as is shown in FIG. 5.

After the pipe connection 1, 1a has been made up to the desired moment, setscrews 16 may be screwed into threaded radial bores 124 in the (first) nut 12, as shown in FIGS. 1, 2, 4 and 5, so that the set screws 16 are pressing against the second nut 13 or the connecting socket 53, securing the (first) nut 12.

It should be noted that all the above-mentioned embodiments illustrate the invention, but do not limit it, and persons skilled in the art will be able to construct many alternative embodiments without departing from the scope of the attached claims. In the claims, reference numbers in parentheses are not to be regarded as restrictive.

The use of the verb “to comprise” and its different forms does not exclude the presence of elements or steps that are not mentioned in the claims. The indefinite article “a” or “an” before an element does not exclude the presence of several such elements.

The fact that some features are indicated in mutually different dependent claims does not indicate that a combination of these features cannot be used with advantage.

1. A pipe connection for sealingly connecting first and second pipes which, at their opposite end portions, are provided with removable rings arranged in grooves provided in the peripheries of the pipes, the pipe connection being provided with a first nut which is provided with an internally threaded portion, is arranged to encircle the end portion of the first pipe and is provided with a shoulder portion which may abut in an axially supporting manner against said ring, and a second nut which is provided with an externally threaded portion, is arranged to encircle the end portion of the second pipe and is provided with a shoulder portion which may abut in an axially supporting manner against said ring, the nuts being in threaded engagement with each other and being arranged to press radial pipe-end faces of the pipes against an axially supporting portion of a seal and pipe carrier unit enclosed by the nuts, characterized in that the axially supporting portion is provided with parallel abutment faces projecting radially inwards, which are each provided with a primary-seal groove provided with a primary seal arranged to sealingly abut against said pipe-end faces, and, extending axially in both directions from the axially supporting portion, there are sleeve-shaped, radially supporting portions which are provided, internally, with respective secondary-seal grooves provided with secondary seals arranged to sealingly abut against the peripheries of the pipes.

2. A pipe connection for sealingly connecting a machined block and a pipe which is provided, in its end portion, with a removable ring arranged in a groove provided in the periphery of the pipe, the pipe connection being provided with a nut which is provided with an internally threaded portion, is arranged to encircle the end portion of the pipe and is provided with a shoulder portion which may abut in an axially supporting manner against said ring, and a connecting socket which is fixed to said block and projects from a seal face encircling a port, is provided with an externally threaded portion and is arranged to encircle the end portion of the pipe, the nut and the connecting socket being in threaded engagement with each other and enclosing a seal and pipe carrier unit and being arranged to press a radial pipe-end face of the pipe against an axially supporting portion of the seal and pipe carrier unit and an end face of the seal and pipe carrier unit against said seal face, characterized in that the axially supporting portion is provided with an abutment face projecting radially inwards and being parallel to said end face, and each of the end face and the abutment face is provided with a primary-seal groove provided with a primary seal arranged to abut sealingly against said pipe-end face and against said seal face, respectively, and, extending axially from the axially supporting portion, there is a sleeve-shaped radially supporting portion which is provided, internally, with a first secondary-seal groove provided with a secondary seal arranged to abut sealingly against the periphery of the pipe, and said end face is provided with a second secondary-seal groove encircling the primary-seal groove of the end face and being provided with a secondary seal arranged to sealingly abut against said seal face.

3. The pipe connection according to claim 1, wherein the primary seal is a metal seal.

4. The pipe connection according to claim 1, wherein the secondary seal is an elastomeric seal.

5. The pipe connection according to claim 1, wherein the secondary seal is an elastomeric seal provided with at least one supporting ring.

6. The pipe connection according to claim 1, wherein the (first) nut is provided with at least one threaded radial bore arranged to receive a set screw for locking the nut relative to a corresponding threaded portion.

7. A method of sealingly connecting first and second pipes or a machined block and a pipe by means of a pipe connection according to claim 1, characterized in that the method comprises the steps:
placing a seal and pipe carrier unit with associated primary and secondary seals between pipe-end faces of adjacent pipes, possibly between the pipe-end face of a pipe and a seal face encircling a port of an adjacent block;
connecting a nut to a corresponding threaded portion in the pipe connection; and
pulling the pipe connection together by means of the nut in order thereby to bring said seals into sealing abutment against the pipe-end faces of the pipes, or against the pipe-end face of the pipe and the seal face.

8. The method according to claim 7, wherein the method includes the further step: locking the nut to the corresponding threaded portion with at least one set screw which is arranged in a threaded radial bore in the nut.
